(19) United States
(12) Patent Application Publication
(10) Pub. No.: US 2026/0065050 A1
(43) Pub. Date: Mar. 5, 2026

(54) TRAINING NEURAL NETWORK MODEL AND PERFORMING INFERENCE USING HETEROGENEOUS PROCESSORS

(71) Applicant: DEEPX CO., LTD., Seongnam-si (KR)

(72) Inventor: Lok Won KIM, Yongin-si (KR)

(21) Appl. No.: 19/052,682

(22) Filed: Feb. 13, 2025

(30) Foreign Application Priority Data
Aug. 28, 2024 (KR) 10-2024-0115722

(51) Int. Cl. G06N 3/08; G06F 8/41

(52) U.S. Cl. CPC G06N 3/08; G06F 8/447

(57) ABSTRACT

A method for training a neural network model based on heterogeneous processing units may comprise: training a neural network model with lightweight weights to be executable on a second processing unit by utilizing a training dataset on a first processing unit; and performing inference on an evaluation dataset using the lightweight weights on the second processing unit.

### CROSS-REFERENCE TO RELATED APPLICATION

This application claims priority to Republic of Korea Patent Application No. 10-2024-0115722, filed on Aug. 28, 2024, which is incorporated herein in by reference in its entirety.

### BACKGROUND

### Technical Field

The present disclosure relates to methods and systems for training neural network models based on heterogeneous processing apparatuses.

### Background Art

Humans have the intelligence to recognize, classify, infer, predict, control/decision making, and the like. Artificial intelligence (AI) is the artificial imitation of human intelligence.

The human brain is made up of tons of nerve cells called neurons. Each neuron is connected to hundreds to thousands of other neurons through connections called synapses. In order to mimic human intelligence, the operation of biological neurons and the connections between neurons are modeled in a neural network (NN) model. In other words, a neural network is a system of nodes connected in a layer structure that mimics neurons.

Neural Network (NN) models are categorized into ‘single-layer neural networks’ and multi-layer neural networks'according to the number of layers. A typical multi-layer neural network includes an input layer, a hidden layer, and an output layer. The input layer is the layer that receives external data, and the number of neurons in the input layer is the same as the number of input variables. The hidden layer is located between the input and output layers and receives signals from the input layer, extracts features, and passes them to the output layer. The output layer receives signals from the hidden layer and outputs them to the outside. The input signals between neurons are multiplied by their respective weights, which have a value between 0 and 1, and then summed up. If this sum is greater than the threshold of the neuron, the neuron is activated and implemented as an output value through the activation function.

On the other hand, increasing the number of hidden layers in a neural network to achieve higher artificial intelligence is called a deep neural network (DNN).

There are many types of DNNs, but convolutional neural networks (CNNs) are known for their ability to extract features from input data and identify patterns in the features. Convolutional neural networks (CNNs) are neural networks that function similarly to how the visual cortex of the human brain processes images. Convolutional neural networks are known to be well suited for image processing. Convolutional neural networks are composed of a series of convolutional channels and pooling channels.

The convolutional operation takes up most of the computation time in a convolutional neural network. Convolutional neural networks recognize objects by extracting the features of the image in each channel by a kernel in the form of a matrix, and providing homeostasis such as movement and distortion by pooling. In each channel, a feature map is obtained by convolution of the input data and the kernel, and then an activation function such as rectified linear unit (ReLU) is applied to generate an activation map for that channel. Pooling can then be applied. The neural network that actually classifies the pattern is located at the end of the feature extraction neural network and is called the Fully Connected Layer. In the computational processing of convolutional neural networks, most of the computations are performed via convolutional or matrix product.

With the development of AI inference capabilities, various electronic devices such as AI speakers, smartphones, smart refrigerators, VR devices, AR devices, AI CCTV, AI robot vacuum cleaners, tablets, laptop computers, self-driving cars, bipedal robots, quadrupedal robots, industrial robots, and the like have been provided with various inference services such as sound recognition, speech recognition, image recognition, object detection, driver drowsiness detection, danger moment detection, and gesture detection using AI.

With the recent development of deep learning technology, the performance of artificial neural network inference services is improving through big data-based learning. These artificial neural network inference services repeatedly train a large amount of training data on an artificial neural network and infer various complex data through the trained neural network model. Therefore, various services are being provided to the electronic devices described above by utilizing artificial neural network technology.

### SUMMARY OF THE DISCLOSURE

Embodiments relate to training a neural network model on a first processing circuit for execution of the trained neural network model on a second processing circuit having a configuration different from the first processing circuit. Training or retraining of the neural network model is performed on a first processing circuit to obtain first weights of the neural network model. The first weights are transferred to the second processing circuit from the first processing circuit. Evaluation results on the performance of the inference at the second processing circuit are generated using the transferred first weights after performing the inference by the second processing circuit. The evaluation results are sent to the first processing circuit to update the first weights into second weights. The second weights are transferred to the second processing circuit to perform inferencing.

In one or more embodiments, the first processing circuit is operable with third weights having a data size larger than a data size of the first weights or the second weights operable on the second processing circuit.

In one or more embodiments, the first processing circuit is a general-purpose graphics processing unit (GPGPU), and the second processing circuit is a neural processing unit (NPU).

In one or more embodiments, the second processing circuit includes an internal memory, a plurality of processing elements coupled to the internal memory and configured to perform multiply-add operations using the first weights or the second weights, and an activation function operation circuit coupled to at least the internal memory or the plurality of processing elements. The activation function applies an activation function to an output from the plurality of processing elements.

In one or more embodiments, the power consumption of the second processing circuit is lower than power consumption of the first processing circuit.

In one or more embodiments, one or more compilation options associated with the neural network model are set for training or re-training at the first processing circuit and deployment at the second processing circuit. Machine code for instantiating the neural network model is generated at the first processing circuit by compiling the neural network model according to the compilation options. The machine code is transferred to the second processing circuit for execution.

In one or more embodiments, one or more compilation options include performing at least one of a pruning algorithm, a quantization algorithm, a parameter refinement algorithm, an outlier alleviation algorithm, a model compression algorithm, a knowledge distillation algorithm, a retraining algorithm, and AI-based optimization algorithms.

In one or more embodiments, the evaluation results include at least one of a temperature profile of the second processing circuit, power consumption of the second processing circuit, a number of operations per unit power consumption, frame per second (FPS), inference per second (IPS), or accuracy.

In one or more embodiments, the evaluation results are generated and sent from the second processing circuit to the first processing circuit on an epoch-by-epoch basis.

### BRIEF DESCRIPTION OF THE DRAWINGS

FIG. 1 is a schematic diagram illustrating an example neural network model.

FIG. 2 is a schematic diagram illustrating a convolutional neural network related to the present disclosure.

FIG. 3 is a diagram illustrating the operation of a convolutional neural network related to the present disclosure.

FIG. 4 is a block diagram illustrating a configuration of a heterogeneous processing device-based neural network model training system, according to one example of the present disclosure.

FIG. 5 is a block diagram illustrating a configuration of a neural network model performance evaluation device, according to one example of the present disclosure.

FIG. 6 is a block diagram illustrating a configuration of a neural processing unit of at least one of the neural processing units, according to one example of the present disclosure.

FIG. 7 is a block diagram illustrating a system for training a neural network model based on heterogeneous processing devices in a neural network model performance evaluation apparatus, according to one example of the present disclosure.

FIG. 8 is a block diagram illustrating a configuration of a compiler of a neural network model performance evaluation apparatus, according to one example of the present disclosure.

FIG. 9 is a block diagram illustrating a configuration of an optimization module of a neural network model performance evaluation apparatus, according to one example of the present disclosure.

FIG. 10 is a schematic diagram illustrating a processing element of one of a plurality of processing elements, according to one example of the present disclosure.

FIG. 11 is an example flowchart illustrating a method for training a neural network model based on heterogeneous processing devices, according to one example of the present disclosure.

### DETAILED DESCRIPTION OF THE EMBODIMENT

Particular structural or step-by-step descriptions for examples according to the concept of the present disclosure disclosed in the present specification or application are merely exemplified for the purpose of explaining the examples according to the concept of the present disclosure.

Examples according to the concept of the present disclosure may be embodied in various forms. Examples according to the concept of the present should not be construed as being limited to the examples described in the present specification or application.

Examples according to the concept of the present disclosure may be applied with various changes. The present disclosure may take many forms. Accordingly, specific examples are illustrated in the drawings and described in detail in the present disclosure. However, this is not intended to limit the examples according to the concepts of the present disclosure to a specific disclosure form. Therefore, it should be understood that all changes, equivalents or substitutes included in the spirit and scope of the present disclosure are included in the present disclosure.

Terms such as first and/or second may be used to describe various components. However, the present disclosure should not be limited by the above terms. These terms are only used for the purpose of distinguishing one component from another. For example, without departing from the scope of rights according to the concept of the present disclosure, a first element may be termed a second element, and similarly, a second element may also be termed a first element.

When an element is referred to as being “connected to” or “in contact with” another element, it is understood that the other element may be directly connected to or in contact with the other element, but other elements may be disposed therebetween. On the other hand, when it is mentioned that a certain element is “directly connected” or “directly connected” to another element, it should be understood that no other element is present therebetween. Other expressions describing the relationship between elements, such as “between” and “immediately between” or “adjacent to”and “directly adjacent to”, etc., should be interpreted similarly.

In the present disclosure, expressions such as “A or B”, “at least one of A or/and B” or “one or more of A or/and B” may include all possible combinations thereof. For example, “A or B”, “at least one of A and B” or “at least one of A or B” may refer to both (1) including at least one A, (2) including at least one B, or (3) including both at least one A and at least one B.

As used herein, expressions such as “first”, “second”, “first or second” may modify various elements, regardless of order and/or importance. Said expressions are used only to distinguish one element from other elements, and does not limit the elements. For example, the first user apparatus And the second user device may represent different user device regardless of order or importance. For example, without departing from the scope of rights described in this disclosure, the first element may be named as the second element, and similarly, the second element may also be renamed as the first element.

Terms used in present disclosure are only used to describe specific examples, and may not be intended to limit the scope of other examples. The singular expression may include the plural expression unless the context clearly dictates otherwise. Terms used herein, including technical or scientific terms, may have the same meanings as commonly understood by one of ordinary skill in the art described in this document.

Among terms used in present disclosure, terms defined in a general dictionary may be interpreted as having the same or similar meaning as the meaning in the context of the related art. Unless explicitly defined in this document, it should not be construed in an ideal or overly formal sense. In some cases, even terms defined in the present disclosure cannot be construed to exclude examples of the present disclosure.

The terms used herein are used only to describe specific examples, and are not intended to limit the present disclosure. Singular expressions include plural expressions unless the context clearly dictates otherwise. In this specification, terms such as “comprise” or “having” are intended to indicate that the described feature, number, step, operation, component, part, or combination thereof is present. Accordingly, it should be understood that the presence or addition of one or more other features, numbers, steps, operations, components, parts, or combinations thereof is not precluded.

Unless defined otherwise, all terms used herein, including technical or scientific terms, have the same meaning as commonly understood by one of ordinary skill in the art to which this disclosure belongs. Terms such as those defined in commonly used dictionaries should be interpreted as having a meaning consistent with the meaning in the context of the related art. Unless explicitly defined in this disclosure, it is not to be construed in an ideal or overly formal sense.

Each feature of the various examples of the present disclosure may be partially or wholly combined or combined with each other. Various examples of the present disclosure are technically capable of various interlocking and driving as can be fully understood by those skilled in the art. Each of the examples of the present disclosure may be implemented independently of each other or may be implemented together in an association relationship.

In describing the examples, descriptions of technical contents that are well known in the technical field to which the present disclosure pertains and are not directly related to the present disclosure may be omitted. This is to more clearly convey the gist of the present disclosure without obscuring the gist of the present disclosure by omitting unnecessary description.

To facilitate understanding of the present disclosure, the following is a brief summary of terms used herein.

GPGPU, or General-purpose computing on graphics processing units, refers to the use of graphics processing units (GPUs), which are traditionally employed for graphics rendering, to perform computations typically handled by a central processing unit (CPU). Through GPGPU, the GPU's capability to manage large amounts of parallel computation is leveraged to execute tasks beyond graphics rendering, such as scientific simulations, machine learning, and other parallelizable computing tasks.

NPU: Abbreviation for neural processing unit, which may refer to a processor specialized for computing a neural network model independent of a central processing unit (CPU).

NN: Abbreviation for neural network, a network of nodes connected in a layer structure, mimicking the way neurons in the human brain are connected through synapses, to mimic human intelligence.

Information of a neural network: The information may include the structure of the network, information about the number of layers, information about the connection relationship of each layer, information about the parameters of each layer, information about the computational processing method, information about the activation function, the data type of the parameters of each layer (e.g., floating-point or integer), and the bitwidth of each parameter.

DNN: Abbreviation for deep neural network, which can refer to an increase in the number of hidden layers of a neural network to achieve higher artificial intelligence.

CNN: Abbreviation for convolutional neural network, a neural network that functions similarly to the visual cortex of the human brain in processing images. Convolutional neural networks are known to be well-suited for image processing and are known for their ability to extract features from input data and identify patterns in the features.

Transformer: The transformer neural network is a DNN based on attention techniques. It utilizes many matrix multiplication operations. A transformer can take an input value and parameters such as query (Q), key (K), and value (V) to obtain an output value, an attentions (Q, K, V). Based on the output value (i.e., the attentions (Q, K, V)), the transformer can process various inference operations.

Kernel: Refers to the weights of the N x M matrix of convolutions. Each layer of the neural network model has a plurality of kernels, and the number of kernels may be referred to as the number of channels, the number of filters, and the like.

In recent years, neural processing units (NPUs) have been developed to accelerate computational speeds for artificial intelligence (AI) applications. However, as the functionality and accuracy required for inference services utilizing neural networks increase, the size of neural network model parameters, computational demands, and the volume of learned parameters have grown significantly. These trends have significantly heightened the performance requirements for processors and memory to handle inference operations effectively.

Meanwhile, NPUs may accelerate AI computation and reduce power consumption. However, various neural processing devices use dedicated neural network models and corresponding dedicated acceleration circuits to accelerate AI operations and reduce power consumption. Therefore, when a neural network model trained on a graphics processing unit is executed on an NPU, the accuracy of the neural network model may become different than when performed on the graphics processing unit.

The computation of conventional neural network models is hindered by excessive power consumption, significant heat generation, processor bottlenecks caused by high memory bandwidth demands, and memory latency. Therefore, various challenges exist in enhancing the computational performance of neural network models, leading to the study of lightweight neural network models to address these issues. Specifically, when the number of parameters of a neural network model are large, the processor may fail to prepare the data required for computation in advance, leading to frequent delays. Moreover, in such cases, the processor may enter a starvation or idle state due to the lack of data supply for processing, rendering it unable to perform actual computations and thereby degrading computational performance.

These challenges can be further intensified by the diverse range of electronic devices employed for on-device AI or edge AI computing. Edge AI computing refers to the peripheral environment where AI computation occurs, encompassing devices that directly generate data as well as various electronic devices situated in close proximity to these data-generating devices. Such systems are commonly referred to as edge AI devices.

For clarification, an edge AI device can be defined as an AI computing system located at the periphery of a cloud computing system, distanced from the servers in the data center, and communicating with those servers. Edge AI devices are also capable of performing tasks that require immediate and reliable performance, such as autonomous robots or self-driving cars, which need to process large volumes of data in under 1/1,000^{th} of a second. Consequently, the range of applications for edge AI devices is expanding rapidly.

Accordingly, embodiments relate to various techniques for lightweighting neural network models to make them suitable for standalone, low-power, low-cost neural processing devices. In other words, the number of parameters of neural network models may be reduced to enable their embedding within electronic devices, allowing for independent operations.

Additionally, embodiments address several aspects to commercialize NPUs designed to process neural network models. First, there is a lack of sufficient information to select an appropriate NPU to execute a neural network model developed by the user. Second, NPUs are in the early stages of commercialization, and determining whether a GPGPU-based neural network model can operate on a specific NPU requires reviewing various questionnaires, data sheets, and obtaining technical support from engineers. In particular, the number of layers, parameter sizes, and special functions of the model can be modified based on the user's needs, making it difficult to generalize the neural network model. Third, it is challenging to predict in advance whether the neural network model developed by the user will run on a specific NPU, as there may be issues where the NPU does not support a certain operation or function following post-purchase evaluation. Fourth, the development environment used by the user is likely to be a GPGPU environment but GPGPUs and NPUs may have differing calculation circuits that process essentially the same algorithm. As a result, every time a neural network model is compiled for an NPU, the computation results may vary due to these differences in calculation circuits. Furthermore, it is not possible to train a neural network model on a GPGPU in a way that fully accounts for the differences in calculation circuits between NPUs and GPGPUs. Fifth, it is difficult to predict how the neural network model developed by the user will perform when executed on a specific NPU. Specifically, it is challenging to determine in advance whether the desired power consumption and frames per second (FPS) requirements will be met.

In particular, predicting the desired performance in advance is challenging because the size of the neural network model's weights, the size of the feature map, the number of layers, the characteristics of the activation function, and other factors vary for each neural network model. Consequently, the inventor of the present disclosure aims to provide a method and apparatus for training a neural network model that enables users to more efficiently determine the optimal NPU product selection and the model optimization conditions for the selected NPU. This can be achieved by offering a solution or service that delivers optimal convenience and value to users by performing all necessary operations in batch online when the AI code (e.g., TensorFlow™, PyTorch™, ONNX™ model file, and the like) is uploaded to a specific online simulation service.

Furthermore, since the on-device NPU may be designed for low-cost, low-power embedded devices, it is typically configured to handle only inference functions, without supporting the training of neural network models.

On the other hand, results and their evaluation from GPGPUs as general-purpose computing device may not always be the same as those from NPUs. Specifically, because NPUs have a pipelined architecture, unlike GPGPUs, the accuracy of neural network model inference performed on GPGPUs may differ from the accuracy of inference performed on NPUs. Therefore, embodiments enable training a neural network model on a GPGPU while measuring the inference accuracy of the model on an NPU to improve its accuracy when executed on the NPU.

Additionally, when evaluating the accuracy of a neural network model trained using an evaluation dataset on a GPGPU, it may be disadvantageous in terms of both speed and power consumption compared to performing the computation on an NPU, which features a relatively simpler structure. Accordingly, embodiments also enable training a neural network model on a GPGPU while measuring its inference accuracy by executing the neural network model on an NPU, in order to improve both speed and power consumption efficiency. The aspect addressed by the present disclosure are not limited to those mentioned above; other aspects, not explicitly outlined, will be apparent to those skilled in the art from the following description.

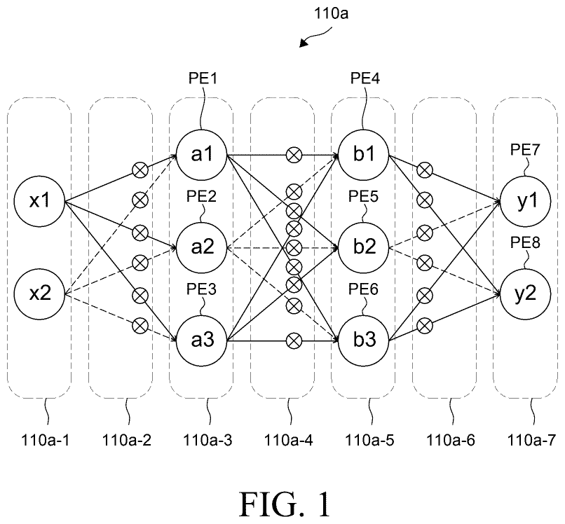

FIG. 1 is a schematic diagram illustrating an example neural network model. Hereinafter, operations of an example neural network model 110a that can be operated in the NPU will be described. The example neural network model 110a of FIG. 1 may be a neural network trained to perform various inference functions such as object recognition, speech recognition, etc. The neural network model 110a may be a deep neural network (DNN). However, the neural network model 110a according to examples of the present disclosure is not limited to a deep neural network. For example, the neural network model 110a may be Siamese Network, Triplet Network, Contrastive Loss, FaceNet, DeepID, SphereFace, ArcFace, Florence-2, DaViT, Mobile ViT, ViT, Swin-Transformer, Transformer, YOLO, CNN, PIDNet, BiseNet, RCNN, VGG, VGG16, DenseNet, SegNet, DeconvNet, DeepLAB V3+, U-net, SqueezeNet, Alexnet, ResNet18, MobileNet-v2, GoogLeNet, Resnet-v2, Resnet50, Resnet101, Inception-v3, and other models. The present disclosure is not limited to the models described above. The neural network model 110a may also be an ensemble model based on at least two different models.

In the following, an inference process performed by the example neural network model 110a will be described. The neural network model 110a is an example deep neural network model including an input layer 110a-1, a first connection network 110a-2, a first hidden layer 110a-3, a second connection network 110a-4, a second hidden layer 110a-5, a third connection network 110a-6, and an output layer 110a-7. However, the present disclosure is not limited to the neural network model shown in FIG. 1. The first hidden layer 110a-3 and the second hidden layer 110a-5 may also be referred to as a plurality of hidden layers.

The input layer 110a-1 may include, for example, x1 and x2 input nodes, i.e., the input layer 110a-1 may include information about two input values.

The first connection network 110a-2 may include information about six weight values for connecting each node of the input layer 110a-1 to each node of the first hidden layer 110a-3. Each weight value is multiplied with the input node value, and an accumulated value of the multiplied values is stored in the first hidden layer 110a-3. The weight values and input node values may be referred to as parameters of the neural network model.

The first hidden layer 110a-3 may include a1, a2, and a3 nodes, i.e., the first hidden layer 110a-3 may include information about three node values.

The first processing element PE1 of FIG. 1 may process operations on the a1 node.

The second processing element PE2 of FIG. 1 may process the operations of the a2 node.

The third processing element PE3 of FIG. 1 may process the operations of the a3 node. The second connection network 110a-4 may include, for example, information about nine weight values for connecting each node of the first hidden layer 110a-3 to each node of the second hidden layer 110a-5. The weight values of the second connection network 110a-4 are each multiplied with the node values input from the first covert layer 110a-3, and the accumulated value of the multiplied values is stored in the second covert layer 110a-5.

The second hidden layer 110a-5 may include nodes b1, b2, and b3, e.g., the second hidden layer 110a-5 may include information about three node values.

The fourth processing element PE4 of FIG. 1 may process operations on the b1 node.

The fifth processing element PE5 of FIG. 1 may process the operations of the b2 node.

The sixth processing element PE6 of FIG. 1 may process the operations of node b3.

The third connection network 110a-6 may include information about six weight values that connect each node of the second hidden layer 110a-5 with each node of the output layer 110a-7, for example. The weight values of the third connection network 110a-6 are each multiplied with the node values input from the second hidden layer 110a-5, and the accumulated value of the multiplied values is stored in the output layer 110a-7.

The output layer 110a-7 may include nodes y1, and y2, e.g., the output layer 110a-7 may include information about two node values.

The seventh processing element PE7 of FIG. 1 may process operations on the y1 node.

The eighth processing element PE8 of FIG. 1 may process the operation of the y2 node.

Each node may correspond to a feature value, and the feature value may correspond to a feature map.

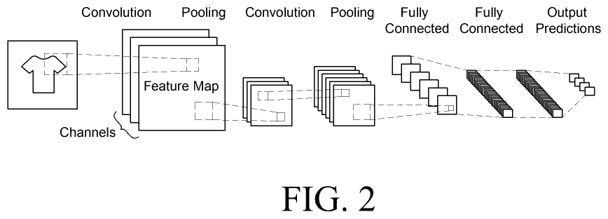

FIG. 2 is a schematic diagram illustrating a convolutional neural network relevant to the present disclosure. A convolutional neural network can be a combination of one or several convolutional layers, a pooling layer, and a fully connected layer. Convolutional neural networks have a structure suitable for learning and inference from two-dimensional data and can be trained using a backpropagation algorithm.

In examples of the present disclosure, the convolutional neural network has a kernel for each channel that extracts features of the input image for the channel. The kernel may be organized as a two-dimensional matrix and performs convolutional operations as it traverses the input data. The size of the kernel can be arbitrary, and the stride at which the kernel traverses the input data can also be arbitrary. The result of the convolution over the entire input data per kernel may be referred to as a feature map or activation map.

In the following, a kernel may include a single set of weights or multiple sets of weights. The number of kernels for each layer may be referred to as the number of channels.

Since the convolutional operation is a combination of input data and kernels, an activation function may then be applied to add nonlinearity. When an activation function is applied to a feature map that is the result of a convolutional operation, it may be referred to as an activation map.

Specifically, referring to FIG. 2, a convolutional neural network may include at least one convolutional layer, at least one pooling layer, and at least one fully connected layer. For example, convolution can be defined by two main parameters: the size of the input data (typically a 1×1, 3×3, or 5×5 matrix) and the depth of the output feature map (the number of kernels). These key parameters can be computed by convolution. These convolutions may start at depth 32, continue to depth 64, and end at depth 128 or 256. The convolution operation may mean an operation of sliding a kernel of size 3×3 or 5×5 over an input image matrix that is input data, multiplying each weight of the kernel and each element of the input image matrix that overlaps, and then adding them all.

An activation function may be applied to the output feature map generated in this way to finally output an activation map. In addition, the weight used in the current layer may be transmitted to the subsequent layer through convolution. The pooling layer may perform a pooling operation to reduce the size of the feature map by down-sampling the output data (i.e., the activation map). For example, the pooling operation may include, but is not limited to, max pooling and/or average pooling.

The maximum pooling operation uses the kernel, and outputs the maximum value in the area of the feature map overlapping the kernel by sliding the feature map and the kernel. The average pooling operation outputs an average value within the area of the feature map overlapping the kernel by sliding the feature map and the kernel. As such, since the size of the feature map is reduced by the pooling operation, the number of weights of the feature map is also reduced.

The fully connected layer may classify data output through the pooling layer into a plurality of classes (i.e., inferenced values), and output the classified class and a score thereof. Data output through the pooling layer forms a three-dimensional feature map, and this three-dimensional feature map can be converted into a one-dimensional vector and input as a fully connected layer.

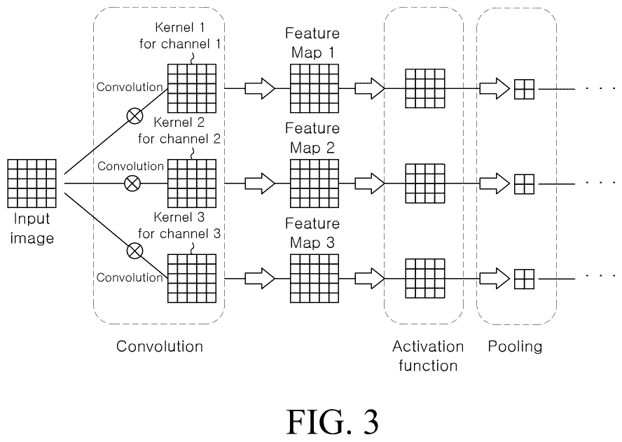

FIG. 3 is a diagram illustrating the operation of a convolutional neural network. Referring to FIG. 3, it is shown that an example input image is a two-dimensional matrix with a size of 6×6. Also, in FIG. 3, three nodes are used, namely channel 1, channel 2, and channel 3.

First, the convolutional behavior is described. The input image (shown as 6×6 in FIG. 3) is convolved with kernel 1 (shown as 3×3 in FIG. 3) for channel 1 at the first node, and feature map 1 (shown as 4×4 in FIG. 3) is output as a result. Further, the input image (represented in FIG. 3 as 6×6 in size) is convolved with a kernel 2 (represented in FIG. 3 as 3×3 in size) for channel 2 at a second node, and feature map 2 (represented in FIG. 3 as 4×4 in size) is output as a result. Further, the input image is convolved with a kernel 3 (represented in FIG. 3 as being 3×3 in size) for channel 3 at the third node, and a feature map 3 (represented in FIG. 3 as being 4×4 in size) is output as a result.

To process each convolution, the processing elements PE1 to PE12 of the NPU are configured to perform MAC operations.

Next, the operation of the activation function will be described. The activation function may be applied to the feature map 1, feature map 2, and feature map 3 (each of which is shown in FIG. 3 as having an example size of 4×4) output from the convolutional operation. The output after the activation function is applied may be an example size of 4×4.

Next, pooling operation will be described. Feature map 1, feature map 2, and feature map 3 (each of which is 4×4 in FIG. 3), which are output from the above activation function, are input to three nodes. By taking the feature maps output from the activation function as input, pooling can be performed. The pooling can be done to reduce the size or to emphasize certain values in the matrix. Pooling methods include maximum value pooling, average pooling, and minimum value pooling. Maximum pooling is used to collect the maximum number of values within a certain region of the matrix, while average pooling can be used to average the values within a certain region.

In the example of FIG. 3, a feature map of size 4×4 is shown to be reduced to a size of 2×2 by pooling. Specifically, the first node takes as input the feature map 1 for channel 1, performs pooling and outputs, for example, a 2×2 matrix. The second node takes as input the feature map 2 for channel 2, performs the pooling, and outputs, for example, a 2×2 matrix. The third node takes as input the feature map 3 for channel 3, performs pooling and outputs, for example, a 2×2 matrix.

The aforementioned convolution, activation function, and pooling are repeated, and finally, the output can be fully connected as shown in FIG. 2.

Among the various deep neural network (DNN) models, CNN is the most popular method in the field of computer vision. In particular, CNN has shown remarkable performance in various research areas performing various tasks such as image classification and object detection.

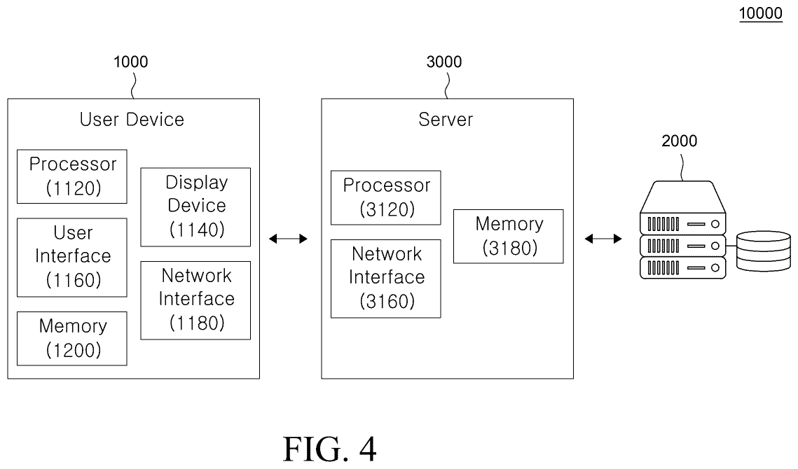

FIG. 4 is a block diagram illustrating a configuration of a heterogeneous processing device-based neural network model training system, according to one example of the present disclosure. Referring to FIG. 4, a heterogeneous processing device-based neural network model training system (hereinafter referred to as a “neural network model training system”) 10000 according to one example of the present disclosure may include a user device 1000, a neural network model performance evaluation device 2000, and a server 3000.

The neural network model training system 10000, according to one example of the present disclosure shown in FIG. 4, may process a particular neural network model in a performance evaluation device for neural network models (hereinafter referred to as a “neural network model performance evaluation device”) 2000, and provide performance evaluation results of the neural network model performance evaluation device 2000 to a user online.

The user device 1000 may refer to a device accessed by the user, and may be used to obtain performance evaluation results from the neural network model performance evaluation device 2000 that processes the neural network model. The user device 1000 may include, among other devices, a smartphone, tablet, PC, laptop, or other devices capable of connecting to the server 3000. The user device 1000 may provide a user interface for accessing information related to the neural network model. In this context, the user device 1000 may also be considered an edge device.

Additionally, the user device 1000 may include a NPU, and a neural network model may be provided by the neural network model performance evaluation device 2000 for execution on the NPU of the user device 1000.

The method by which the user device 1000 connects to the server 3000 may include connecting via a web service, an FTP server, a cloud server, or an application on the user device 1000. However, such connection method is not limited to these options and may employ various known communication technologies.

The user may transmit information about the neural network model to the server 3000 using various communication technologies. Specifically, the user may upload at least one specific neural network model and at least one evaluation dataset of the model to the server 3000 via the user device 1000, in order to evaluate the performance of a neural processing device that the user is interested in purchasing.

The particular evaluation dataset described above may refer to a dataset that is input to the neural network model performance evaluation device 2000 for performance evaluation of the neural network model.

The user device 1000 may receive a performance evaluation result from the neural network model performance evaluation device 2000 for the neural network model, and may output the performance evaluation result provided by the neural network model performance evaluation device 2000.

The user device 1000 can be any kind of terminal capable of uploading information about the neural network model to be evaluated by the neural network model training system 10000 to the server 3000. Also, the user device 1000 may be any type of terminal capable of uploading a test dataset for evaluating the neural network model to the neural network model training system 10000. Further, the user device 1000 may be any kind of terminal capable of uploading a train dataset for retraining the neural network model to neural network model training system 10000. In other words, the user device 1000 may be a data transmission unit for performance evaluation of the neural network model or a performance evaluation result reception unit for the neural network model.

To this end, the user device 1000 may include at least one of the following components: a processor 1120, a display device 1140, a user interface 1160, a network interface 1180, and a memory 1200. The display device 1140 may present options for selecting one or more neural processing devices. Additionally, the display device 1140 may present options for compiling a neural network model. The memory 1200 may store executable software that allows the processor 1120 to access the server 3000. The memory 1200 may also store neural network models and performance evaluation datasets for transmission via the server 3000 to the neural network model performance evaluation device 2000. The user interface 1160 may include input devices such as a keyboard and a mouse. The user interface 1160 may facilitate user input for selecting one or more NPUs to process the neural network model and for selecting compilation options associated with compiling the neural network model. The network interface 1180 may be a hardware component (e.g., a network interface card) that enables the user device 1000 to communicate with the server 3000 over a network.

The neural network model performance evaluation device 2000 may include at least one NPU for processing the neural network model received from the user device 1000 via the server 3000. The neural network model performance evaluation device 2000 may also compile and evaluate the neural network models. The performance of the processed neural network model may be determined, and the performance results may be reported to the user device 1000 via the server 3000.

The neural network model performance evaluation device 2000 may include a system comprising one or more of a general-purpose computer, a laptop, a cloud computer, a cloud server, or the like that performs various programs for determining information about a neural processing device. The neural network model performance evaluation device 2000 may obtain from the server 3000 at least one specific neural network model for evaluating the performance of the neural processing device and at least one specific evaluation dataset that is input to the neural network model, compile and process the neural network model, and provide performance evaluation results.

The server 3000 is a computing device in communication with the user device 1000 to manage access to the neural network model performance evaluation device 2000. The server 3000 may include a processor 3120, a network interface 3160, and memory 3180. The network interface 3160 enables the server 3000 to communicate with the user device 1000 and the neural network model performance evaluation device 2000 over a network. Memory 3180 can store instructions executable by processor 3120 to perform one or more of the following tasks: (i) managing a user account, (ii) authorizing and enabling user access to the neural network model processing device 1000 for evaluating one or more neural processing devices, (iii) receiving user inputs, including a selected neural network model, an evaluation dataset, selected neural processing devices for evaluation, and compilation options, (iv) encrypting and storing data received from the user, (v) transmitting the neural network model and the user's processor selection information to the neural network model processing device 1000 over the network, and (vi) transmitting performance reports for the selected neural processing devices, along with recommendations, to the user device 1000 over the network. The server 3000 may also be configured to provide various additional services as needed.

To elaborate, neural network models, training datasets, evaluation datasets, and similar assets developed by users constitute the intellectual property of the users and demand stringent security measures. In many cases, training datasets for the development of commercially viable AI services can hold a value ranging from hundreds of thousands to hundreds of millions of U.S. dollars. Hereinafter, such assets, including neural network models, training datasets, and evaluation datasets developed by a user, are collectively referred to as user data. To ensure the security of user data uploaded to the neural network model training system 10000, the system may incorporate several protective measures. These may include user account login authentication, data encryption, differential privacy techniques, and data masking to safeguard the data itself. Additionally, mechanisms such as access control and audit logging may be implemented to regulate and monitor model access and usage.

Data encryption can be utilized to secure user data, ensuring the confidentiality of the information by converting it into a coded format that is accessible only to authorized parties. Differential privacy can apply statistical techniques to reduce the sensitivity of user data, particularly when it contains personal information, thereby safeguarding individual privacy. Data masking can protect user data by concealing sensitive information through obfuscation, such as replacing parts of the data with pseudonymous values or symbols.

Access to user data can also be restricted through access control mechanisms, ensuring that only authorized accounts are permitted entry. Audit logging can be implemented to record which accounts have accessed user data, maintaining detailed logs of system and user data interactions. These logs can track who accessed the model and when, aiding in the detection of unusual activity and enhancing security oversight.

Additionally, users may be required to sign a separate user data protection agreement when uploading the training dataset and/or evaluation dataset. This ensures that the user's neural network model, training dataset, and evaluation dataset are protected.

A neural network model performance evaluation system, according to an example of the present disclosure, may be configured to utilize a neural network model training system based on heterogeneous processing devices. The details of the heterogeneous processing device-based neural network model training system will be described later.

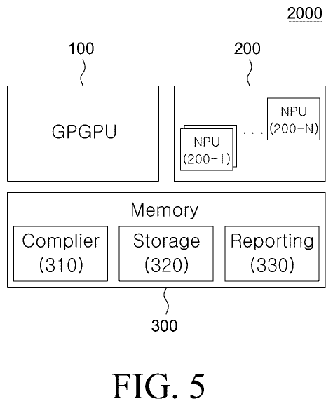

Referring to FIG. 5, a neural network model performance evaluation device 2000 will be described. FIG. 5 is a block diagram illustrating a configuration of a neural network model performance evaluation device, according to one example of the present disclosure. The neural network model performance evaluation device 2000 may include a general-purpose computing on graphics processing unit (GPGPU) 100, at least one NPU 200, and a memory 300. Each configuration of the neural network model performance evaluation device 2000 may communicate with each other via one or more communication buses or signal lines. The neural network model performance evaluation device 2000 may be operated by a particular operating system (OS). For example, the OS may be Microsoft Windows, MacOS, Linux (e.g., Ubuntu, Fedora, Debian, CentOS, Arch Linux), Unix, iOS, Android, or the like.

According to one example of the present disclosure, a neural network model performance evaluation device 2000 may include at least one GPGPU 100 and at least one NPU 200-1. The GPGPU 100 may be configured to be executable by instructions. The NPU 200-1 may be configured to be executable by instructions.

First, the GPGPU 100 is hardware that performs complex computational tasks, as well as graphics and image processing. The number of GPGPU 100 illustrated is one, but is not limited thereto, and a plurality of GPGPUs connected by a cloud GPU, NVLink, NVSwitch, or the like may be used.

The GPGPU 100 may include a plurality of cores, and the plurality of cores may process multiple tasks in parallel. Thus, the GPGPU 100 may perform large-scale data processing tasks such as scientific computation and deep learning.

Specifically, the GPGPU 100 may be employed to train deep learning and machine learning models on large datasets. While deep learning models typically have a substantial number of parameters and involve a significant amount of time for training, the GPGPU 100 can execute these operations in parallel, thereby accelerating the learning process of the neural network model. The GPGPU 100 can be utilized effectively when a user selects a specific NPU from among one or more NPU 200 and performs training or retraining of a neural network model using various compilation options. A suitable graphics processing device is selected based on the user's requirements, and the chosen device can conduct retraining of the neural network model according to the specified compilation options.

In other words, the GPGPU 100 may receive a training dataset uploaded by the user device 1000 through the server 3000 and utilize it to train or retrain the neural network model. For instance, during the retraining process, the GPGPU 100 may apply a pruning algorithm and/or a quantization algorithm to the neural network model alongside the training dataset to conduct retraining. This retraining may be performed over multiple epochs, with the GPGPU 100 capable of executing several to hundreds of epochs as part of the process.

The retraining option is a technique that can compensate for degraded inference accuracy upon application of various optimization options. For example, when applying a quantization option, a pruning option, or a model compression option, the accuracy of the neural network model inferred by the one or more NPUs 200 may be degraded. In such cases, an option may be provided to retrain the pruned, quantized, and/or model compressed neural network model online. The inference accuracy of the retrained neural network model may increase again.

Meanwhile, the GPGPU 100 may include one or more operating processors for executing instructions stored in the memory 300. Further, CPU 700 in the neural network model performance evaluation device 2000 may load and execute the compiler 310 stored in the memory 300. Machine code generated by the CPU 700 may be loaded and executed by GPGPU 100 to perform training or retraining of the neural network model.

The one or more NPUs 200 may be implemented as an NPU farm, consisting of various families of NPUs with differing performance levels and price points, offered by a specific company. This NPU farm may be made available online to facilitate the performance evaluation of neural network models developed by users. The NPU farm may also be provided in the form of a cloud-based NPU. However, the examples described in the present disclosure are not limited to NPU farms and impose no restrictions on the number of individual NPUs (e.g., 200-1) included within the at least one NPU 200.

The one or more NPUs 200 may include various types of NPUs.

More specifically, the one or more NPUs 200 may be categorized based on computational power.

For example, a first NPU may be a NPU for a smart CCTV. The first NPU may have the characteristics of ultra-low power, low-level inference processing power (e.g., 5 TOPS of processing power), very small semiconductor package size, and very low price. Due to performance limitations, the first NPU may not support certain NN models that include certain operations and require high memory bandwidth. For example, the first NPU may be “DX-V1” available from DEEPX CO., LTD. of Seongnam-si, Gyeonggi-do, Republic of Korea, and may compute NN models such as ResNet, Mobilenet v1/v2, SSD, YOLOv5, YOLOv7, and the like.

For example, the second NPU may be a NPU for image recognition, object detection, and object tracking of a robot. The second NPU may have the characteristics of low power, moderate inference processing power (e.g., 16 TOPS of processing power), small semiconductor package size, and low price. The second NPU may not support certain NN models that involve high memory bandwidth. For example, the second NPU may have a model name “DX-V2” also available from DEEPX CO., LTD., and may compute NN models such as ResNet, Mobilenet v1/v2, SSD, YOLOv5, YOLOv7, and the like.

For example, the third NPU may be a NPU for image recognition, object detection, object tracking, and generative AI services for autonomous vehicles. The third NPU may have low power, high level inference processing power (e.g., 25 TOPS of processing power), medium semiconductor package size, and medium price. For example, the third NPU may have a model name “DX-M1” also available from DEEPX CO., LTD., and may compute NN models such as ResNet, MobileNet v1/v2/v3, SSD, EfficientNet, EfficientDet, YOLOv5, YOLOv7, YOLOv8, DeepLabv3, PIDNet, VIT, Generative adversarial network, Stable diffusion, and the like.

For example, the fourth NPU may be a NPU for CCTV control rooms, control centers, large language models, and generative AI services. The fourth NPU may have low power, high level inference processing power (e.g., 400 TOPS of processing power), large semiconductor package size, and high price characteristics. For example, the fourth NPU may have a model name “DX-H1”, also available from DEEPX CO., LTD., and may compute NN models such as ResNet, Mobilenet v1/v2, SSD, YOLOv5, YOLOv7, YOLOv8, DeepLabv3, PIDNet, ViT, Generative adversarial network, Stable diffusion, and large LLM.

In other words, each NPU can have different computational processing power, different semiconductor chip die sizes, different power consumption characteristics, and the like. However, the types of the plurality of NPUs 200 are not limited thereto and may be categorized by various classification criteria.

Meanwhile, the one or more NPUs 200 may receive an evaluation dataset uploaded by the user device 1000 via the server 3000 and feed it into the compiled neural network model to perform a performance evaluation. The evaluation dataset refers to an evaluation dataset that is input for performance evaluation of the neural network model performance evaluation device 2000.

Based on the selected compilation options, the input neural network model may be compiled, and the resulting machine code along with the evaluation dataset may be transmitted to the selected NPU 200-1 within the NPU farm for processing. The compilation options may be configured according to the user's preferences and can include multiple variations, allowing the user to specify different options tailored to their specific needs. In other words, the neural network model training system 10000, based on heterogeneous processing devices, may provide compilation options in a user-customized manner rather than relying solely on predefined options, thereby accommodating the detailed requirements of the user.

The one or more compilation options may include at least one of a pruning algorithm, a quantization algorithm, a parameter refinement algorithm, an outlier alleviation algorithm, a model compression algorithm, a knowledge distillation algorithm, a retraining algorithm, and AI-based optimization algorithms.

Alternatively, the compilation option may be configured to select one of the available preset options. Furthermore, a performance evaluation result for the NPU 200-1 that processed the compiled neural network model, i.e., the processing performance, may be generated and reported. The performance evaluation result report may be stored in the user's account or sent to the user's email address. However, without limitation, the performance evaluation results may be provided to the user through various other means. These performance evaluation results are also classified as user data and may be subject to the security policies governing user data.

The parameters of processing performance may be a temperature profile of the NPU, power consumption (Watt), trillion operations per second per Watt (TOPS/W), frame per second (FPS), inference per second (IPS), accuracy, and the like.

Meanwhile, the GPGPU 100 and the at least one NPU 200 may be implemented in the form of an integrated chip (IC), such as a system on chip (SoC) that integrates various computational circuits, or a printed circuit board on which the integrated chip is mounted.

The memory 300 may store various software, including, but not limited to, the compiler 310, the storage module 320, and the reporting program 330.

In addition, the memory 300 can include a volatile or non-volatile recording medium that can store various data, instructions, and information.

For example, the memory 300 may include a storage medium of at least one of the following types: flash memory type, hard disk type, multimedia card micro type, card type memory (e.g., SD or XD memory, etc.), RAM, SRAM, ROM, EEPROM, PROM, network storage, cloud, and blockchain database.

As previously described, the CPU 700 in the neural network model performance evaluation device 2000 may load and execute a compiler 310 stored in the memory 300. The compiler 310 may be implemented as a semiconductor circuit or as software stored in the memory 300 and executed by the CPU 700. However, the present disclosure is not limited to these implementations. In some embodiments, the compiler 310 may be software executed by GPGPU 100.

The compiler 310 may translate a specific neural network model into machine code executable by the one or more NPUs 200. In other words, the compiler 310 may generate machine code executable by the various NPUs 200, each with different characteristics. Accordingly, the compiler 310 may produce machine code adapted for execution on a selected NPU 200-1 from among the one or more NPUs 200. This machine code may also be referred to as binarized code. The compiler 310 may generate machine code for a neural network model specifically to evaluate the performance of the selected NPU 200-1 from one or more NPUs 200.

The compiler 310 may provide various compilation options, which may be displayed as a user interface (UI) on the screen of the user device 1000, allowing the user to select the desired compilation options. These compilation options may be set differently for each NPU selected for performance evaluation, enabling the generation of machine code tailored for the selected neural network model.

Since the plurality of compilation options may vary depending on the type of the one or more NPUs 200, the compiled machine code for the same neural network model may differ based on the type of the one or more NPUs 200. In other words, separate machine code may be generated for each selected compilation option. The storage module 320 may store various data utilized by the neural network model performance evaluation device 2000. Specifically, the storage module 320 may store one or more of the compiled neural network model as machine code, one or more training datasets, one or more evaluation datasets, performance evaluation results, and output data generated by the one or more NPUs 200.

The reporting program 330 may process the compiled neural network model to report the results of said performance evaluation. That is, the reporting program 330 may first determine whether the compiled neural network model is capable of being processed by the one or more NPUs 200.

If the compiled neural network model is not processable by the one or more NPUs 200, the reporting program 330 may report a particular layer of the plurality of layers of the neural network model that is not processable by the one or more NPUs 200, or a particular operation that is not processable.

If the compiled neural network model is executable by a particular NPU of the one or more NPUs 200, the reporting program 330 may report the processing performance of the at least one NPU 200.

The parameters of processing performance of the NPU may be one or more of a temperature profile, power consumption (Watt), trillion operations per second per Watt (TOPS/W), frame per second (FPS), inference per second (IPS), accuracy, and the like.

Temperature profile refers to the temperature change data of a NPU measured over time when the NPU is operating.

Power consumption refers to power data measured when the NPU is operating. Because power consumption depends on the computational load of the user-developed NN model, the user's NN model may be provided and deployed for accurate power measurement.

Trillion operations per second per watt (TOPS/W) is a metric that measures the efficiency of AI accelerator, meaning the number of operations that can be performed for one second per watt. TOPS/W is an indicator of the energy efficiency of the one or more NPUs 200, as it represents how many operations the hardware can perform per unit of power consumed.

Inference Per Second (IPS) is an indicator of the number of inference operations that the one or more NPUs 200 can perform in one second, thus indicating the computational processing speed of the one or more NPUs 200. IPS may also be referred to as frame per second (FPS).

Accuracy refers to the inference accuracy of the one or more NPUs 200, as an indicator of the percentage of samples correctly inferenced out of the total. As further explained, the accuracy of the one or more NPUs 200 and the inference accuracy of the graphics processing unit 100 may differ. This is because the parameters of the neural network model inferred by the graphics processing unit 100 may be in a form of floating-point, while at least a portion of the parameters of the neural network model inferred by the one or more NPUs 200 may be in a form of integers. Further, various optimization algorithms may be optionally applied. Thus, the parameters of the neural network models inferred by the one or more NPUs 200 may have differences in values calculated by various operations, and thus may have different inference accuracies from the neural network models inferred by the graphics processing unit 100. The difference in inference accuracy may depend on the structure and parameter size characteristics of the neural network model, and in particular, the shorter the length of the bitwidth of the quantized parameter, the greater the degradation in inference accuracy due to excessive quantization. For example, the quantized bitwidth can be from 2-bit to 16-bit. The degradation of inference accuracy due to excessive pruning also tends to be larger.

As further detailed, certain NPU may include circuitry specifically designed to execute multiply-accumulate (MAC) operations using integer parameters only, while others may include circuitry tailored for processing MAC operations with floating-point parameters only. Some NPUs may feature circuitry capable of processing MAC operations with 32-bit parameters as input, while others may support MAC operations with 16-bit or 8-bit parameters as input. Additionally, certain NPUs may be equipped with circuitry designed to handle MAC operations with parameters of varying bit widths as input. These differences in parameter formats and processing capabilities may lead to variations in inference results, even when the same evaluation dataset is used for inference on the GPGPU 100 and a specific NPU 200-1, respectively.

As further explained, certain NPU may include circuitry designed to process activation function operations by approximation, while other NPU may include circuitry designed to process activation function operations based on lookup tables. These differences in approximation function processing may result in different inference results when the same evaluation dataset is inferred on the GPGPU 100 and the specific NPU 200-1, respectively.

Meanwhile, the reporting program 330 may analyze the processing performance of the compiled neural network model according to each of the plurality of compilation options, and may recommend one of the plurality of compilation options in reverse. In addition, the reporting program 330 may also recommend a particular type of NPU 200 based on performance parameters of different NPUs.

Meanwhile, the reporting program 330 may analyze the processing performance of the compiled neural network model for each of the plurality of compilation options and may, in turn, recommend an optimal compilation option. Furthermore, the reporting program 330 may also suggest a specific type of NPU 200 based on the performance parameters of various NPUs.

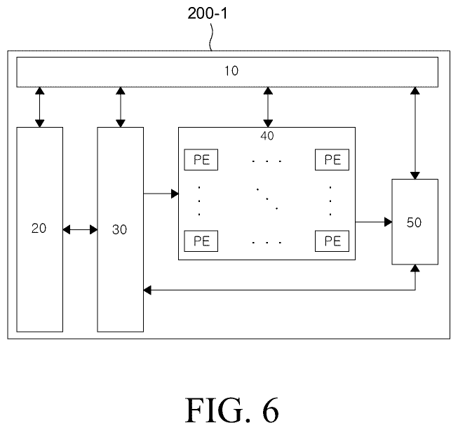

FIG. 6 is a block diagram illustrating a configuration of a NPU of at least one of the NPUs, according to one example of the present disclosure. The one or more NPUs 200 may be controlled via a controller. Specifically, the controller may perform scheduling for memory access operations and computation operations prior to each of the NPUs 200-1, . . . , 200-N directly accessing, reading and/or writing to the memory 300 or the like.

Referring to FIG. 5 and FIG. 6, each of the NPUs 200-1 through 200-N may include a controller 10, a direct memory access (DMA) module 20, an internal memory 30, a plurality of processing elements 40, and a special function unit 50. For the purpose of the following description, the NPU 200-1 will be described as a representative example of the at least one NPU 200. This is solely for the convenience of explanation and is equally applicable to all NPUs within the one or more NPUs 200.

The elements of the NPU 200-1 are distinguished based on their operational functions, and each element may be implemented using at least one of a substrate, a resistive element, or a transistor. Consequently, each element may constitute a semiconductor circuit comprising numerous interconnected transistors, some of which may be challenging to identify or distinguish visually and can only be identified through their functionality. Therefore, the functional units of the neural processing device 200-1 may be collectively referred to as circuit units.

The controller 10 may be configured to manage the operations required for computing ,.the neural network model by coordinating the DMA 20, the internal memory 30, the plurality of processing elements 40, and the special function unit 50. The controller 10 may be directly or indirectly coupled to these components to facilitate communication. For instance, the controller 10 may dynamically adjust the allocation of parameters in the internal memory 30 based on its capacity. The controller 10 may also control the NPU 200-1 by executing machine code (e.g., binary code) generated from a compiled neural network model. For example, the compiler may produce machine code that defines the following operations based on the hardware characteristics of a specific NPU 200-1 (e.g., number of processing elements, memory capacity, functionality of the special function unit, presence of a post-processing unit, etc.): the read/write sequence for neural network model data, the processing order of the neural network layers, the processing order of convolutional or matrix multiplication operations, and the read and write operation sequence for the DMA. Accordingly, the controller 10 executes control of the NPU 200-1 in accordance with the machine code, ensuring performance aligned with the hardware's capabilities.

The controller 10 may obtain scheduling information to manage the sequence of operations of the neural network model executed by the NPU 200-1. This scheduling is based on a directed acyclic graph (DAG) of the neural network model, compiled by the compiler. The compiler may generate an operation schedule by considering factors such as the number of processing elements (PEs) in the NPU 200-1, the size of the internal memory 30, the size of the parameters for each layer of the neural network model, and similar parameters.

Based on this operation schedule, the controller 10 may control the number of processing elements for each computation step and manage the read and write operations for parameters in the internal memory 30 at each step. The compiler may determine the operation schedule by leveraging its understanding of the hardware architecture and performance characteristics of the NPU 200-1. Additionally, the compiler may determine the sequence of data required for the computations of the neural network model, taking into account the order of operations across layers, convolutions, and matrix multiplications. This ensures data locality and generates efficient machine code for execution.

In some examples, the NPU 200-1 may include an embedded compiler. Based on the configurations described above, the NPU 200-1 may be capable of generating machine code directly from input files formatted as frameworks of various AI software. Examples of such AI software frameworks include TensorFlow, PyTorch, Keras, XGBoost, MXNet, Darknet, ONNX, and others.

The DMA 20 may enable the NPU 200-1 to directly access, read from, and write to the memory 300. The NPU 200-1 may retrieve various data associated with the neural network model from the memory 300 through the DMA 20. The memory 300 may either be embedded within a system-on-chip (SoC) or implemented as a separate memory device. The internal memory 30, located within the on-chip region of the NPU 200-1, may serve as a cache memory, storing or caching data processed within the on-chip region.

The internal memory 30 may retrieve and store from the memory 300 at least a subset of the parameters required for computing the neural network model. It may store all or a portion of the neural network model, depending on the memory capacity allocated to each parameter and the data size of each layer within the model. Representative parameters processed in the neural network model may include Attention, KV cache, activation maps, input feature maps, output feature maps, weights, and similar elements.

Specifically, the internal memory 30 may retrieve and store parameters associated with input data from the memory 300. Additionally, it may read and store parameters associated with output data generated by the plurality of processing elements 40. As detailed further below, the parameters of the neural network model may include input parameters and weights. Input or output parameters read from or written to the internal memory 30 may include activation parameters, feature map parameters, KV cache parameters, attention parameters, and related data types.

The internal memory 30 may include one or more types of memory, such as ROM, SRAM, DRAM, Resistive RAM, Magneto-resistive RAM, Phase-change RAM, Ferroelectric RAM, Flash Memory, HBM, or similar technologies. In one example, the internal memory 30 may be implemented as SRAM, which provides advantages in terms of computation processing speed. Furthermore, the internal memory 30 may be organized into one or more memory units, such as banks or similar structures. It may also comprise either homogeneous memory or heterogeneous memory configurations.

The data stored in the memory unit of the internal memory 30, such as the parameters of the neural network model, may not be fixed to a specific type (e.g., Attention, KV cache, activation map, input feature map, weight, or output feature map). Instead, it may dynamically change to another type based on computational requirements. In other words, by adjusting the memory allocation within the internal memory 30, its utilization efficiency can be enhanced. Consequently, the data size allocated for each type of parameter stored in the internal memory 30 may vary depending on the specific computation step.

The plurality of processing elements 40 may be configured to include a processing element array and/or an adder tree for performing MAC operations.

Each processing element 40 may receive and compute an input feature map corresponding to the input data of the neural network and/or a kernel corresponding to the weights.

These processing elements are capable of performing operations such as addition, multiplication, accumulation, and other functions necessary for processing the neural network model. To facilitate this, each processing element may incorporate a multiply-and-accumulate (MAC) operator, an arithmetic logic unit (ALU) operator, or similar components.

For instance, a processing element may receive input feature maps and weights, execute a convolution or matrix multiplication operation, and generate an output feature map. Furthermore, the plurality of processing elements 40 may also be referred to as artificial intelligence (AI) computational units.

In another example, the processing element may perform a general matrix multiply (GEMM) operation or a matrix multiply operation on the input feature map and weights to output an output feature map. More specifically, the processing element may multiply the input feature map in the form of a matrix with a weight matrix, and then add a bias to the matrix to output an output feature map in the form of a matrix. In particular, in the NPU, the matrix multiplication may be performed at high speed through parallel processing, thereby enabling efficient processing of the matrix multiplication operation.

As another example, the processing element may comprise circuitry designed to process only integer type parameters as input. In such a case, the input parameters of the processing element may be converted to integers of a specific bit-width and stored in the internal memory 30. According to the above-described configuration, the power consumption can be effectively reduced compared to a processor supporting floating point, and it is easy to be implemented on-device.

The special function unit 50 may process a number of activation functions for imparting nonlinearity to the output feature map.

The special function unit 50 may process various activation functions to introduce nonlinearity to the output feature map. The activation functions processed by the special function unit 50 may include, but are not limited to, the SiLU function, Softmax function, sigmoid function, hyperbolic tangent (tanh) function, ReLU function, Leaky ReLU function, Maxout function, or ELU function, each of which results in a nonlinear output value relative to the input value.

On the other hand, it may be technically difficult to support all activation functions in the NPU 200-1. Therefore, the NPU 200-1 may approximate various activation functions through a piecewise linear function approximation algorithm and piecewise linear function processing circuitry. These activation functions can be optionally applied after the MAC operation. The operational value to which the activation function is applied may be referred to as the activation map.

On the other hand, supporting all activation functions in the NPU 200-1 may present technical challenges. Therefore, the NPU 200-1 may approximate various activation functions using a piecewise linear function approximation algorithm and associated piecewise linear function processing circuitry. These activation functions may optionally be applied following the MAC operations. The operational value to which the activation function is applied is referred to as the activation parameters.

Further, the special function unit 50 may be configured to include a floating-point multiplier circuit for performing decimal point operations.

As another example, the special function unit 50 may include circuitry configured to communicate with the processing element and designed to receive an integer-type parameter from the processing element. In this case, the special function unit 50 may further incorporate an inverse quantizer circuit, which is responsible for converting the integer-type parameter into a floating-point-type parameter. The special function unit 50 may then be configured to perform an activation function operation using the floating-point-type parameters. Additionally, the special function unit 50 may include a quantization circuit designed to convert the floating-point parameter, after the activation function operation, back into an integer-type parameter. According to this configuration, the special function unit 50 is capable of processing floating-point operations by de-quantizing the integer parameter when a floating-point operation is needed, and then re-quantizing the resulting parameter. In other words, a NPU, according to one example of the present disclosure, may include a processing element circuit unit configured to process integer-type parameters and a special function circuit unit pipelined to the processing element. The circuit for the special function unit may include both a quantization circuit and an inverse quantization circuit, and may be configured to perform activation function operations using floating-point-type parameters. This configuration allows the special function unit 50 to effectively interface with a processing element that supports only integer parameters, enabling it to directly convert parameter types and process them without requiring additional circuitry outside the NPU.

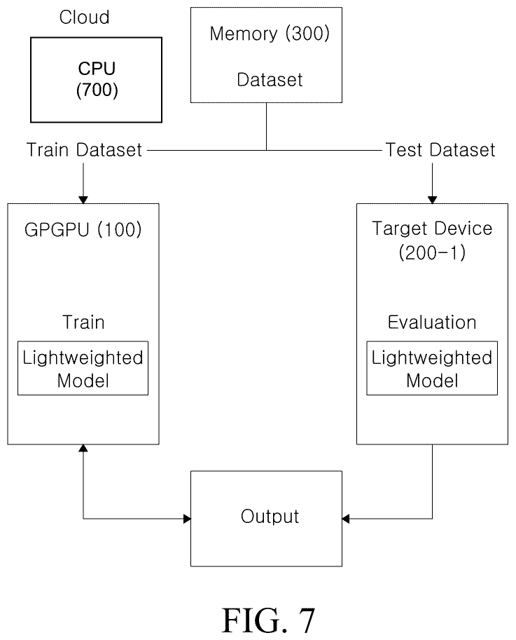

FIG. 7 is a block diagram illustrating a system for training a neural network model based on heterogeneous processing devices in a neural network model performance evaluation apparatus, according to one example of the present disclosure. Referring to FIG. 7, the GPGPU 100 may read the parameters of the neural network model and a training dataset from memory 300 to train the neural network model. During the training process, as the weights are updated, they are passed to the target device (e.g., NPU 200-1) at which the performance of the trained neural network model is evaluated. In one or more embodiments, memory 300 may receive the updated weights from GPU 100 and send the updated weights to NPU 200-1 or alternatively, GPU 100 may send at least a portion of the updated weights directly to NPU 200-1. Consequently, the NPU 200-1 may perform an evaluation of the trained neural network model, using the parameters of the trained model stored in memory 300 and a test dataset for model evaluation.

In other words, according to one example of the present disclosure, the training of the neural network model is handled by the GPGPU 100, while the evaluation of the trained neural network model is managed by NPU 200-1. Here, by performing the evaluation by NPU 200-1, inference accuracy of the trained neural network model can be determined with the updated weights.

As a result of the evaluation, the processing performance of the trained neural network model can be obtained. In this context, the processing performance may be represented by accuracy. However, this is just one example, and other metrics, such as perplexity, processing speed and/or power consumption may be used to indicate the processing performance. The result of the evaluation (e.g., inference results processed by NPU 200-1) may be stored in memory 300 and sent to the GPGPU 100. Ground truth (e.g., answers of the evaluation dataset) of the evaluation dataset may be provided with the neural network model training system 10000. For example, the ground truth of the evaluation dataset may be stored in the memory 300. The inference results are compared with the ground truth of the evaluation dataset. Thus, accuracy of the trained weights trained by GPGPU 100 inferenced by NPU 200-1 with evaluation dataset can be determined by GPGPU 100 or CPU 700 by receiving the inference results output from NPU 200-1.

Thereafter, the GPGPU 100 may perform training or retraining on an epoch-by-epoch basis, continuously updating the weights stored in memory 300 with the recent values based on evaluated accuracy of the trained weight. The updating of the weights may be performed in a manner so that the accuracy is increased. Whenever the weights are updated through retraining, they may be transmitted to NPU 200-1 in a repeating manner (e.g., epoch-by-epoch basis) in order to increase the inference accuracy of the weights trained for NPU 200-1.

The memory 300 may be configured to store updated weights of at least one epoch. Each of the weights corresponding to each epoch can be stored in memory 300 for comparison purpose. In addition, each accuracy result corresponding to each epoch can be stored in memory 300 for comparison purpose. The memory 300 may be configured to store updated weights of a plurality of epochs. The memory 300 may be configured to store the updated weights of the at least one epoch processed on the first processing device (e.g., GPGPU) and the corresponding evaluation results processed on the second processing device (e.g., NPU).

The memory 300 may be configured to store updated weights of a plurality of epochs processed on the first processing device and corresponding evaluation results processed on the second processing device.

As previously described, a training dataset and an evaluation dataset for training or retraining may be stored in memory 300. The neural network model performance evaluation device 2000 may obtain (or store) each of the training dataset and the evaluation dataset as they are uploaded to the server 3000 by the user device 1000. In another embodiment of the present disclosure, the NPU 200-1 may communicate the output processing performance, such as the inferred accuracy, to the GPGPU 100. In this case, the general-purpose graphics processing unit 100 would receive feedback on the processing performance of the neural network model it has trained or retrained.

As described above, the GPGPU 100, according to the present disclosure, transmits only the weights updated through the training or retraining of the neural network model to the NPU 200-1, with the evaluation of the trained or retrained model being performed by the NPU 200-1. This approach allows the GPGPU 100 to accelerate the evaluation process, as it does not need to allocate resources for the model evaluation, thereby reducing the time spent on this task.

Furthermore, when the target device for the neural network model is the neural processing device 200-1, the inference accuracy is likely to be the highest when the model is executed directly on the target device. As previously mentioned, when the GPGPU 100 is used to emulate the target device, it may not perfectly replicate the target device's behavior. Additionally, the GPGPU 100 and the NPU 200-1 may have different computational circuit configurations, even when processing the same algorithm. Consequently, the computation results may differ each time a neural network model is compiled for the neural processing device 200-1, due to differences in both the calculation circuits and the format of the parameters used by the model.

Moreover, it may be difficult to train the neural network model on the GPGPU 100 in a way that fully reflects the differences in the calculation circuits between the GPGPU 100 and the NPU 200-1. In other words, after the GPGPU trains the neural network model by updating its weights, the target device uses the updated weights and evaluates its inference accuracy. The inference accuracy as determined by the target device may be fed back to GPGPU so that the weights of the neural network model may again be updated. By feeding the accuracy evaluated by the target device and iteratively updating the weights by the GPGPU, the neural network model may become adapted specifically to the target device. As a result, the inference accuracy of the neural network model on the target device can be increased.

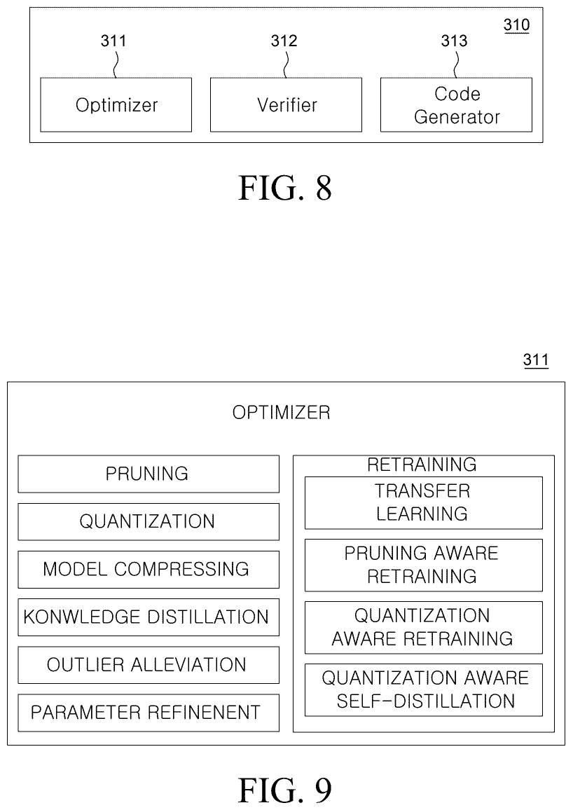

FIG. 8 is a block diagram illustrating a configuration of a compiler of a neural network model performance evaluation apparatus according to one example of the present disclosure. Referring to FIG. 8, the compiler 310 of the neural network model performance evaluation device 2000 may compile the neural network model into machine code based on a plurality of compilation options. The compiler 310 of the neural network model performance evaluation device 2000 may include an optimization module 311, a verifier module 312, and a code generator module 313. The optimization module 311 of the compiler 310 may instruct GPGPU 100 to modify or retrain the weights of the neural network model for its deployment on NPU 200-1.

The compiler 310 may be provided with structural data of a target NPU selected from the one or more NPUs 200. The structural data of the NPU may include one or more of: the memory capacity of the internal memory of the NPU, the hierarchical structure of the internal memory, information regarding the number of processing elements, information about special function units, and similar details. The compiler 310 may determine a processing order for each layer based on the structural data of the NPU and the graph information of the neural network model to be compiled. In this context, the target device (e.g., a particular NPU) is configured to execute the machine code that compiles the neural network model, and the machine code may be adapted for the calculation circuits of the target device.

The optimization module 311 may be responsible for improving the neural network model, represented as a directed acyclic graph (DAG), for the selected NPU from the one or more NPUs 200. The user may select at least one of various options provided by the optimization module 311.

For example, the optimization module 311 may provide an option to convert to an integer parameter of a specific bitwidth. The specific bitwidth may range between 2 bits and 16 bits. As a result, the optimization module 311 may convert a neural network model based on floating-point parameters to one based on integer parameters. In this case, the one or more NPUs 200 are designed to process integer parameters. Additionally, the optimization module 311 may convert a neural network model based on nonlinear functions into one based on piecewise linear function approximation. The at least one NPU 200 may be designed to process such piecewise linear function approximations.

For instance, the piecewise linear function approximation operation may be performed in various ways, such as by segmenting the entire segment and approximating each segment with a linear function, segmenting a portion of the segment and approximating each portion with a linear function, or using a linear function to approximate the entire segment.

In other words, the optimization module 311 may apply various optimization algorithms to reduce the size of parameters, such as weights and feature maps, in the neural network model so that it can be executed on NPU 200-1 to produce more accurate results. As part of this process, the optimization module 311 may mitigate any accuracy deterioration of the optimized neural network model through various retraining algorithms.

The verification module 312 may perform a verification process to determine whether the customer's neural network model is executable on the one or more NPUs 200. The verification module 312 may analyze the structure of the optimized neural network model and check whether the operators for each layer are supported by the hardware of the one or more NPUs 200. If the model is found to be infeasible, a separate error report file may be generated and provided to the user.

The code generation module 313 may modify the neural network model, determined to be operable by the verification module 312 and processed by the optimization module 311, and generate machine code that executes the updated neural network model on the selected NPU from the at least one NPU 200. The generated machine code may be provided to the corresponding target NPU to enable performance evaluation.

Furthermore, the code generation module 313 may offload certain operations of the target neural network model that are deemed inoperable by the verification module 312 to be executed on a heterogeneous processor (e.g., DSP, GPGPU, CPU, etc.). For example, a first machine code corresponding to the first neural network model may be generated for a first NPU of one or more NPUs 200. A second machine code corresponding to the first neural network model may be generated for a second NPU of one or more NPUs 200. A third machine code corresponding to the first neural network model may be generated for a third NPU of one or more NPUs 200. A fourth machine code corresponding to the first neural network model may be generated for a fourth NPU of one or more NPUs 200.

FIG. 9 is a block diagram illustrating a configuration of an optimization module of a neural network model performance evaluation apparatus, according to one example of the present disclosure. The optimization module 311 may modify the neural network model based on a plurality of compilation options. More specifically, the optimization module 311 may set the compilation options based on hardware information of the NPU 200-1. Further, the optimization module 311 may set the plurality of compilation options in consideration of characteristics of parameters of the neural network model (e.g., size of a weight parameter, size of a feature map, etc.) and characteristics of inference accuracy deterioration.

The plurality of compilation options set using the optimization module 311 may be at least one of a pruning option, a quantization option, a model compression option, a knowledge distillation option, an outlier alleviation option, a parameter refinement option, and a retaining option.

Activation of the pruning option may provide techniques for reducing the computation of a neural network model. The pruning algorithm may replace small, near-zero values with zeros in the weights of one or more layers of the neural network model, and thereby sparsify the weights. The one or more NPUs 200 can skip multiplication operations associated with zero weights to speed up the computation of convolutions, reduce power consumption, and reduce the parameter size in the machine code of the neural network model with the pruning option. Zeroing out a particular weight parameter by pruning is equivalent to disconnecting neurons corresponding to that weight data in a neural network. The pruning options may include a value-based first pruning option that removes smaller weights or a percentage-based second pruning option that removes a certain percentage of the smallest weights.

Activation of the quantization option may provide a technique for reducing the size of the parameters of the neural network model. The quantization algorithm may selectively reduce the number of bits in the weights and the feature maps of each layer of the neural network model. When the quantization option reduces the number of bits in a particular feature map and particular weights, it can reduce the overall parameter size of the machine code of the neural network model. For example, a 32-bit parameter of a floating-point can be converted to a parameter of 2-bit through 16-bit integer when the quantization option is active.

Activation of the model compression option applies techniques for compressing the weight parameters, feature map parameters, and the like of a neural network model. The model compression technique can be implemented by utilizing known compression techniques in the art. This can reduce the parameter size of the machine code of a neural network model with the model compression option. The model compression option may be provided to a NPU including a decompression decoder.

Activation of the knowledge distillation option applies a technique for transferring knowledge gained from a complex model (also known as a teacher model) to a smaller, simpler model (also known as a student model). In a knowledge distillation algorithm, the teacher model typically has larger parameter sizes and higher accuracy than the student model. For example, in the retraining option described later, the accuracy of the student model can be improved with a knowledge distillation option in which a neural network model trained with floating-point 32-bit parameters may be set as the teacher model and a neural network model with various optimization options may be set as the student training model. The student model may be a model with at least one of the following options selected: pruning option, quantization option, model compression option, and retraining option.

Activation of the parameter refinement option applies a technique that can be performed in conjunction with the quantization option. In order to reduce the error that may occur according to quantization, and to reduce the memory bandwidth caused by quantization while maintaining the accuracy of the neural network model, optimization can be performed on the parameters required for the quantization process. According to the parameter refinement option, optimal values can be calculated for each of the scale value and offset value for quantization of the floating-point parameters of the neural network model.

Activation of the outlier alleviation option applies a technique that can be performed in conjunction with the quantization option. The input values and/or weights of a neural network model may contain outliers according to the actual data, which can cause quantization errors to be amplified during the quantization process. For effective quantization, it is necessary to properly compensate for outliers. According to an outlier mitigation option, an adjustment value for outlier adjustment may be used to adjust the outliers contained in the input parameters and the weight parameters before the MAC operation.

Activation of the retraining option applies a technique that can compensate for degraded inference accuracy when applying one or more optimization options. For example, when applying a quantization option, a pruning option, or a model compression option, the accuracy of a neural network model inferred by the one or more NPUs 200 may decrease. In such cases, an option may be provided to retrain the pruned, quantized, and/or model-compressed neural network model to recover the accuracy of the inference.

Specifically, the retraining option may include a transfer learning option, a pruning-aware retraining option, a quantization-aware retraining option, a quantization aware self-distillation option, and the like.

Activation of the quantization-aware retraining (QAT) option incorporates quantization into the retraining phase of the neural network model, where the model fine-tunes the weights to reflect quantization errors. The quantization-aware retraining algorithm can include the loss function, gradient calculation, and optimization algorithm modifications. The quantization-aware retraining option can compensate for quantization errors by quantizing the trained neural network model and then performing fine-tuning to retrain it in a way that minimizes the loss due to quantization.

Activation of the quantization aware self-distillation option is intended to perform QAT while avoiding underfitting problems during retraining, such that when minimizing the loss between the inference values resulting from running the model and the labeled values of the training data, the retraining can also take into account the loss between the inference values and the results of running a simulated quantization model on the same parameters. In one example, according to the quantization-aware self-distillation option, when the difference between the inference value of the pre-trained model using the parameter represented by the 32-bit floating point and the actual result value is the first loss, and the difference between the inference value of the quantization simulation model and the inference value of the pre-trained model for the same parameter is the second loss, the pre-trained model may update the parameters so that the first loss is reduced while retraining. The parameters may be updated such that the second loss is reduced while the quantization simulation model is retrained.

In order to reduce the problem associate with applying QAT to a pre-trained model that has already been trained using data augmentation, the regularization may become excessive and leads to over-generalization, quantization-aware self-distillation can be performed. According to quantization-aware self-distillation, the difference between the inference value of the quantization simulation using the same parameters and the inference value of the pre-trained model can be reflected to minimize the accuracy drop caused by excessive regularization.

Activation of the pruning-aware retraining (PAT) option identifies and removes less important weights from the trained neural network model and then fine-tunes the active weights. Pruning criteria can include weight value, activation values, and sensitivity analysis. The pruning-aware retraining option may reduce the size of the neural network model, increase inference speed, and compensate overfitting problem during retraining.

Activation of the transfer learning option allows a neural network model to learn by transferring knowledge from one task to another related task. Transfer learning algorithms are effective when there is not enough data to begin with, or when training a neural network model from scratch that requires a lot of computational resources.

Without limitation, the optimization module 311 can apply an artificial intelligence-based update to the neural network model. An artificial intelligence-based optimization algorithm may be a method of generating a lightweight neural network model by applying various algorithms from the compilation options. This may include exploring the structure of the neural network model using an AI-based reinforcement learning method or a method that is not based on a reduction method such as a quantization algorithm, a pruning algorithm, a retraining algorithm, a model compression algorithm, but rather a method in which an artificial intelligence integrated in the optimization module 311 performs a reduction process by itself to obtain an improved reduction result.

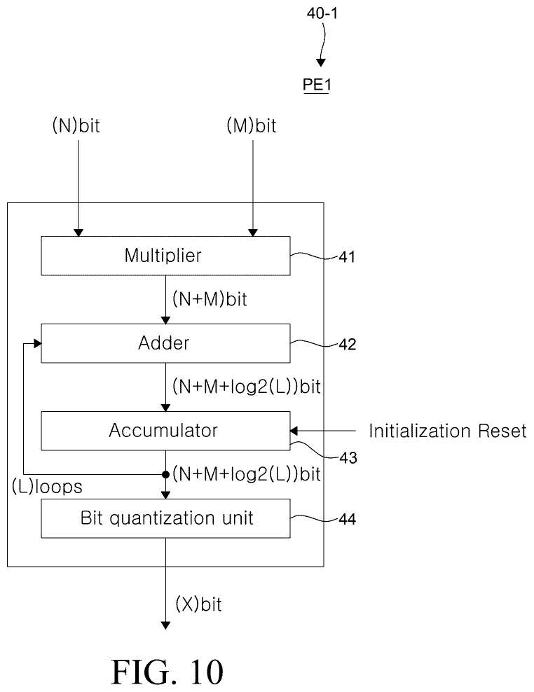

FIG. 10 is a schematic diagram illustrating a processing element of one of a plurality of processing elements that may be applicable to one example of the present disclosure.

The NPU 200-1, according to one example of the present disclosure, may include a plurality of processing elements 110, an NPU internal memory 120 configured to store a neural network model that can be inferred by the plurality of processing elements 110, and an NPU controller 130 configured to manage the operations of the plurality of processing elements 110 and the NPU internal memory 120. The plurality of processing elements 110 may be designed to perform MAC operations and quantize the results of the MAC operations before outputting them. However, the examples of the present disclosure are not limited thereto.

Referring to FIG. 10, the processing element 40-1 may be configured to include a multiplier 41, an adder 42, an accumulator 43, and a bit quantization unit 44. However, the examples according to the present disclosure are not limited, and the processing element 40-1 may be modified to account for the computational characteristics of a target neural network model.

The multiplier 41 may multiply the input (N)-bit data and the (M)-bit data. The result of the multiplier 41 operation is output as (N+M)-bit data, where N and M are integers greater than zero. The first input that receives the (N)-bit data may be configured to receive a parameter having a variable characteristic (e.g., activation parameters), and the second input that receives the (M)-bit data may be configured to receive a parameter having a constant characteristic (e.g., weight parameters). However, the input data to the multiplier 41 is not limited to constant parameters and variable parameters.

For example, according to examples of the present disclosure, the input parameters of the processing element 40-1 can be reused based on the characteristics of the constant parameters and variable parameters, which can improve the computational efficiency of the NPU 200-1.

Here, a parameter with a variable characteristic refers to a parameter whose value, stored at a specific memory address, can be dynamically updated whenever the incoming input parameters are modified. For example, the activation parameter of each layer may represent a MAC operation value that incorporates the weight parameters of a neural network model. When the neural network model is used for object detection in video data, the activation parameter of each layer will vary as the input video changes frame by frame.

A parameter with a constant characteristic, in this context, refers to a parameter whose value remains unchanged at its designated memory address, regardless of updates to incoming input parameters. For example, a learned weight parameter may serve as a unique inference criterion for a neural network model. This learned weight parameter does not vary, even when the neural network model is employed for tasks such as object detection in video data.

That is, the multiplier 41 may be configured to receive one variable parameter and one constant parameter as inputs. Specifically, the variable parameter provided to the first input may represent an activation parameter of a layer within the neural network model. This activation parameter may correspond to the activation parameter of an input layer, an accumulated parameter of a hidden layer, or an accumulated parameter of an output layer. Meanwhile, the constant parameter provided to the second input may represent a weight parameter of the neural network model.

The controller 10 may be configured to improve memory reuse by taking into account the nature of the constant parameters.

The variable parameters may be computational values of each layer, and the controller 10 may recognize reusable variable parameters based on the machine code of the compiled neural network model, and control the internal memory 30 to reuse the memory.

The constant parameters may be the weight parameters of each layer, and the controller 10 may recognize the repeatedly used constant parameters based on the structural data of the neural network model or the neural network data locality information, and control the internal memory 30 to reuse the parameters stored in the memory.

That is, the controller 10 may know reusable variable parameters and reusable constant parameters based on the machine code of the compiled neural network model. Accordingly, the controller 10 may be configured to control the internal memory 30 to reuse the parameters stored in the internal memory 30.

The processing element 40-1 may constrain the operation of the multiplier 41 such that when a zero is input at an input of one of the first input and the second input of the multiplier 41, the multiplier 41 may not perform an operation because the processing element 40-1 knows that the result of the operation will be zero even if the operation is not performed.

For example, when a zero is input to an input of one of the first input and the second input of the multiplier 41, the multiplier 41 may be configured to operate in a zero-skipping manner.

The number of bits for each parameter input to the first and second inputs may be determined based on the quantization of the activation and weight parameters for each layer of the neural network model. For example, the activation parameter of the first layer may be quantized to 5-bits, while the weight parameter of the first layer may be quantized to 7-bits. In this case, the first input may be configured to receive a 5-bit parameter, and the second input may be configured to receive a 7-bit parameter. Accordingly, the number of bits for the parameter input to each input may differ.

The processing element 40-1 may be designed to receive quantization information for the parameters input to the respective inputs. Additionally, the neural network data locality information may include the quantization details of both the input and output parameters of the processing element 40-1.

The NPU 200-1 may be configured to control the real-time conversion of quantized bitwidth when the quantized parameters stored in the internal memory 30 are input to the processing element 40-1. Specifically, different layers may have different quantized bitwidth, and the processing element 40-1 may be designed to generate input parameters by performing real-time bitwidth conversion. This conversion may be executed based on bit count information provided by the NPU 200-1, ensuring that the bitwidth of the input parameters are appropriately adjusted during the conversion process.

The accumulator 43 utilizes the adder 42 over a number of (L) loops to accumulate the operation result from the multiplier 41 and the operation result from the accumulator 43. Consequently, the bit width of the data at the output and input of the accumulator 43 may be expressed as (N+M+log2(L))bits, where L is an integer greater than zero.

When the accumulator 43 finishes accumulating, the accumulator 43 may receive an initialization reset signal to initialize the data stored inside the accumulator 43 to zero. However, examples according to the present disclosure are not limited thereto.

The bit quantization unit 44 may be configured to reduce the bitwidth of the data output from the accumulator 43. This bit quantization unit 44 may operate under the control of the controller 10. The bitwidth of the quantized data may be output as (X) bits, where (X) is an integer greater than zero. With this configuration, the processing element 40-1 is designed to perform a MAC operation and is capable of quantizing and outputting the result of the MAC operation. Specifically, this quantization has the additional effect of reducing power consumption as the number of (L) loops increases. Lower power consumption further contributes to reducing heat generation in edge devices. Furthermore, minimizing heat generation has the critical effect of decreasing the likelihood of operational malfunctions caused by elevated temperatures in the NPU 200-1.

The output parameter (X)-bit from the bit quantization unit 44 may represent an activation parameter for the next layer or an input parameter for a convolutional operation (or matrix multiplication). If the neural network model is quantized, the bit quantization unit 44 may be configured to receive the quantization information directly from the neural network model. Alternatively, without limitation, the controller 10 may be configured to analyze the neural network model to extract the necessary quantization information. As a result, the output parameter (X)-bit may be converted into the corresponding number of quantized bits, based on the size of the quantized parameter. The output parameter (X)-bit from the bit quantization unit 44 may then be stored in the internal memory 30 as a quantized value with the appropriate bitwidth.

The processing element 40-1 of the NPU 200-1 according to one example of the present disclosure may include a multiplier 41, an adder 42, an accumulator 43, and a bit quantization unit 44. The bit quantization unit 44 may reduce the number of bits of data in (N+M+log2(L))bits output from the accumulator 43 by the processing element 40-1 to a number of bits in (X) bits. The controller 10 may control the bit quantization unit 44 to reduce the number of bits in the output data by a predetermined number of bits from the least significant bit (LSB) to the most significant bit (MSB). Reducing the number of bits in the output data may have the effect of reducing power consumption, computation, and memory usage. However, if the number of bits is reduced below a certain length, the inference accuracy of the neural network model may decrease rapidly. Therefore, the quantization level, i.e., the reduction of the number of bits in the output data, can be determined by comparing the degree of reduction in power consumption, computation, and memory usage with the degree of reduction in the inference accuracy of the neural network model. The quantization level can also be determined by determining a target inference accuracy for the neural network model and testing it with progressively lower bitwidth. The quantization level can be determined separately for each layer of the neural network model.

According to the processing element 40-1 described above, by adjusting the number of bits of the (N)-bit parameter and the (M)-bit parameter of the multiplier 41 and reducing the number of bits of the operation value (X)-bit by the bit quantization unit 44, the processing element 40-1 has the effect of improving the MAC operation speed while reducing the power consumption, and also has the effect of making the convolution operation (or matrix multiplication operation) of the neural network model more efficient.

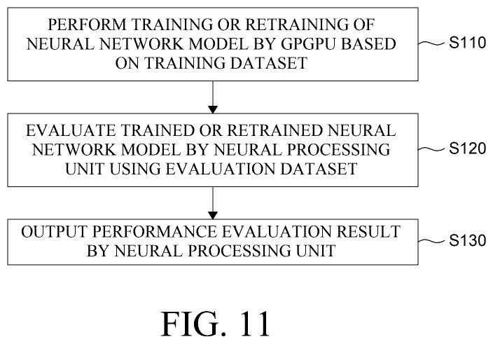

FIG. 11 is an example flowchart illustrating a method for training a neural network model based on heterogeneous processing devices, according to one example of the present disclosure. Referring to FIG. 11, the GPGPU 100 performs operations for training or retraining a neural network model based on the training dataset S110.

For this process, a user may upload the training dataset to the server 3000 via the user device 1000. The user may then select, via the user device 1000, the type and number of at least one NPU to be evaluated for performance, as well as one or more compilation options for the neural network model to be processed by the selected NPU. These selections set the compilation options for the neural network model.

In step S110, the confirmed compilation options for the neural network model are verified, and the model is compiled accordingly. The compiled machine code is then input to the selected NPU from the available devices. As part of training or retraining the neural network model in step S110, the model's weights are updated, and the updated weights are communicated to the selected NPU.

In some embodiments, the operations for training or retraining the neural network model may focus on lightweighting the weights of the neural network model. Various algorithms may be applied for this purpose, such as pruning, quantization, parameter refinement, outlier alleviation, model compression, knowledge distillation, retraining, and AI-based model optimization algorithms.

Next, in step S120, the selected NPU 200-1 evaluates the trained or retrained neural network model using the evaluation dataset. For this process, a user may upload the evaluation dataset to the server 3000 via the user device 1000. During step S120, the selected NPU 200-1 applies the updated weights from step S110 to the trained or retrained model to perform the evaluation operation. The selected NPU 200-1 then outputs the performance evaluation result in step S130. This result may include an accuracy metric or other evaluation metric based on the performance of the model.

Although not shown in FIG. 11, after step S130, the selected NPU 200-1 may report the performance evaluation result to the user device based on one or more predefined methods. Additionally, steps S110 through S130 may be performed iteratively, allowing for the retraining of the neural network model on an epoch-by-epoch basis.

In summary, training a neural network model on heterogeneous processing devices, as described in one example, involves using a training dataset on a first processing device to train a neural network model that is modified to be executable on a second processing device (hereinafter also referred to as “a lightweighted model”) by updating its weights, and then performing inference using the modified neural network model executed the second processing device. At each epoch, the first processing device compares the inference results of current epoch and prior epochs based on the evaluation dataset, and selects a set of weights in one of the current and prior epochs that yields the better performance at the second processing device for deployment by the second processing device.

In one example, the first processing device may be a GPGPU, and the second processing device may be an NPU where the NPU is specialized for accelerated AI inference operations but not training operations.

For example, in the conventional method, the inference accuracy at the GPGPU may be highest at an epoch (e.g., epoch 3). Hence, the weights updated by the dataset in the epoch (e.g., epoch 3) that yields the best inference accuracy at the GPGPU may be selected for deployment and execution on the NPU. In contrast, according to embodiments, weights updated by the dataset at another epoch (e.g., epoch 4) that yields the best inference accuracy at the NPU is selected for deployment at the NPU despite its lower inference accuracy at the GPGPU relative to the epoch (e.g., epoch 3). Hence, the weights yielding the better performance at the target NPU is selected and deployed at the target NPU, not the weights that results in the better performance at the GPGPU.

Since the inference accuracy evaluation is performed directly on the target device (i.e., NPU) rather than emulating the NPU on the GPGPU, the inferred accuracy may be higher with the method described in the present disclosure compared to the conventional method. Additionally, by enabling collaboration between heterogeneous processing devices for both training and evaluation, the overall training speed can be significantly accelerated.

As described, the present disclosure allows training of a neural network model on a general-purpose graphics processing unit (e.g., GPGPU) but its performance is evaluated based on its execution on target hardware (e.g., NPU), reducing the time required for evaluation and thereby accelerating the overall evaluation process.

Embodiments relate to training a neural network model based on heterogeneous processing units. A neural network model is trained with lightweight weights to be executable on a second processing unit by utilizing a training dataset on a first processing unit. Inference on an evaluation dataset may be performed using the lightweight weights on the second processing unit.

In one or more embodiments, the first processing unit may be configured to train the neural network model with the lightweight weights based on an inference result of the evaluation dataset.

In one or more embodiments, the training the neural network model may further comprises retraining the neural network model.

In one or more embodiments, the first processing unit may be a general-purpose graphics processing unit (GPGPU), and the second processing unit may be a neural processing unit (NPU).

In one or more embodiments, the second processing unit may be a neural processing unit (NPU) specialized for AI operation acceleration, configured to support inference operations but not training operations.

In one or more embodiments, the second processing unit may include an internal memory, a plurality of processing elements, and an activation function operation unit.

In one or more embodiments, power consumption of the second processing unit may be relatively lower than power consumption of the first processing unit.

In one or more embodiments, the training the neural network model with the lightweight weights may comprise: transmitting an inference result of the second processing unit to the first processing unit, and updating the lightweight weights based on the inference result.

In one or more embodiments, an inference accuracy of the neural network model may be evaluated by transmitting the lightweight weights, trained by the first processing unit, to the second processing unit. The second processing unit may process inference on the evaluation dataset using the lightweight weights. An inference result may be compared with a correct answer.

In one or more embodiments, the training the neural network model may include: setting one or more compilation options for the neural network model, generating machine code by compiling the neural network model according to the compilation options, transmitting the machine code to the second processing unit, and executing the machine code on the second processing unit.

In one or more embodiments, the training the neural network model may include: setting one or more compilation options, wherein the one or more compilation options may include at least one of a pruning algorithm, a quantization algorithm, a parameter refinement algorithm, an outlier alleviation algorithm, a model compression algorithm, a knowledge distillation algorithm, a retraining algorithm, and AI-based optimization algorithms.

In one or more embodiments, the second processing unit may be configured to execute machine code compiled from the neural network model. The machine code is programmed for the arithmetic circuit of the second processing unit.

In one or more embodiments, the training the neural network model with the lightweight weights may be performed in units of epochs.

Embodiments relate to a system for training a neural network model using heterogeneous processing units. At least one memory may be configured to store a training dataset and an evaluation dataset. A first processing unit may be configured to train lightweight weights of the neural network model using the training dataset, such that the model is executable by a second processing unit. The second processing unit may be configured to perform inference on the evaluation dataset using the lightweight weights.

In one or more embodiments, the first processing unit may be a general-purpose graphics processing unit (GPGPU), and the second processing unit may be a neural processing unit (NPU).

In one or more embodiments, the second processing unit may be a neural processing unit (NPU) specialized for AI operation acceleration, configured to support inference operations but not training operations.

In one or more embodiments, the second processing unit may be configured to execute machine code compiled from the neural network model, the machine code is programmed for the arithmetic circuit of the second processing unit.

In one or more embodiments, the neural network model may be incorporated with one or more algorithms, including a pruning algorithm, a quantization algorithm, a parameter refinement algorithm, an outlier alleviation algorithm, a model compression algorithm, and at least one of a knowledge distillation algorithm, a retraining algorithm, or an AI-based model optimization algorithm.

In one or more embodiments, the lightweight weights updated in the first processing unit may be transmitted to the second processing unit. The first processing unit may be configured to perform training of the lightweight weights based on an inference result of the evaluation dataset processed by the second processing unit using the lightweight weights.

In one or more embodiments, the first processing unit may be configured to train the lightweight weights of the neural network model on an epoch-by-epoch basis.

The examples of the present disclosure disclosed herein and in the drawings are provided solely to explain the technical content of the present disclosure and to facilitate understanding of the present disclosure, and are not intended to limit the scope of the present disclosure. It will be apparent to one of ordinary skill in the art to which the present disclosure belongs that other modifications based on the technical ideas of the invention may be practiced in addition to the examples shown herein.

### National Research And Development Project That Supported This Invention

[Assignment number] 00399936
[Ministry Name] Ministry of Science and ICT
[Name of project management (professional) organization] Korea Information and Communication Planning and Evaluation Institute
[Research project name] Artificial intelligence semiconductor SW integrated platform technology development
[Research project name] Bench Mark Test (BMT) platform technology development for edge AI semiconductor
[Name of project carrying out organization] DeepX
[Research period] 2024.04.01˜2027.12.31

1. A method for training a neural network model, comprising:
training or retraining a neural network model on a first processing circuit to obtain first weights of the neural network model;
transferring the first weights as transferred weights to a second processing circuit having a configuration different from the first processing circuit and with limited capability relative to the first processing circuit;
performing inference by the second processing circuit using the neural network model and the transferred weights;
generating inference results and evaluation results on the performance of the inference at the second processing circuit using the neural network model and the transferred weights, responsive to performing the inference by the second processing circuit;
sending the evaluation results from the second processing circuit to the first processing circuit;
performing training or retraining by the first processing circuit at least based on the evaluation results to modify a structure of the neural network model and to update the first weights for execution on the second processing circuit;
sending the updated first weights associated with an updated neural network model with the modified structure from the first processing circuit to the second processing circuit; and
performing inference by the second processing circuit using the updated neural network model and the updated first weights.

2. The method of claim 1, wherein the first processing circuit is operable with second weights having a data size larger than a data size of the first weights operable on the second processing circuit.

3. The method of claim 2, wherein the first processing circuit is a general-purpose graphics processing unit (GPGPU), and the second processing circuit is a neural processing unit (NPU).

4. The method of claim 2, wherein the second processing circuit includes:
an internal memory;
a plurality of first circuits coupled to the internal memory and configured to perform multiply-add operations using the first weights or the second weights; and
a second circuit coupled to at least the internal memory or the first circuits, and configured to apply an activation function to an output from the first circuits.

5. The method of claim 1, wherein power consumption of the second processing circuit is lower than power consumption of the first processing circuit.

6. The method of claim 1, further comprising:
setting one or more compilation options associated with the neural network model for training or retraining at the first processing circuit and deployment at the second processing circuit;
generating machine code for instantiating the neural network model at the first processing circuit by compiling the neural network model according to the compilation options; and
transmitting the machine code to the second processing circuit for execution.

7. The method of claim 1, wherein modifying the structure of the network model includes performing at least one of a pruning algorithm, an outlier alleviation algorithm, a model compression algorithm, a knowledge distillation algorithm, a retraining algorithm, or AI-based optimization algorithms.

8. The method of claim 1, wherein the evaluation results include at least one of a temperature profile of the second processing circuit, power consumption of the second processing circuit for performing the inference, a number of operations per unit power consumption, frame per second (FPS), inference per second (IPS), or accuracy of the inference.

9. The method of claim 1, wherein the evaluation results are generated and sent from the second processing circuit to the first processing circuit on an epoch-by-epoch basis.

10. A system for generating a neural network model, comprising:
a first processing circuit configured to:
train or retrain a neural network model to obtain first weights of the neural network model,
receive evaluation results,
retrain the neural network model based on the received evaluation results to modify a structure of the neural network model and to update the first weights, and
send the updated first weights associated with an updated neural network model with the modified structure, and
a second processing circuit having a configuration different from the first processing circuit and with limited capability relative to the processing circuit, the second processing circuit configured to:
receive the first weights,
perform inference using the neural network model and the received first weights,
generate inference results and the evaluation results on the performed inference, responsive to performing the inference using the neural network model and the received first weights,
send the evaluation results to the first processing circuit,
receive the updated first weights associated with the updated neural network model from the first processing circuit, the updated first weights and the updated neural network model configured to be executed on the second processing circuit, and
perform inference using the updated neural network model and the updated first weights.

11. The system of claim 10, wherein the first processing circuit is operable with second weights having a data size larger than a data size of the first weights operable on the second processing circuit.

12. The system of claim 11, wherein the first processing circuit is a general-purpose graphics processing unit (GPGPU), and the second processing circuit is a neural processing unit (NPU).

13. The system of claim 10, wherein the second processing circuit includes:
an internal memory;
a plurality of first circuits coupled to the internal memory and configured to perform multiply-add operations using the first weights or the second weights; and
a second circuit coupled to at least the internal memory or the first circuits, and configured to apply an activation function to an output from the first circuits.

14. The system of claim 10, wherein power consumption of the second processing circuit is lower than power consumption of the first processing circuit.

15. The system of claim 10, further comprising one or more processors configured to:
set one or more compilation options associated with the neural network model for training or retraining at the first processing circuit and deployment at the second processing circuit,
generate machine code for instantiating the neural network model at the first processing circuit by compiling the neural network model according to the compilation options, and
transmit the machine code to the second processing circuit for execution.

16. The system of claim 10, wherein the structure of the neural network model is modified by performing at least one of a pruning algorithm, an outlier alleviation algorithm, a model compression algorithm, a knowledge distillation algorithm, a retraining algorithm, or AI-based optimization algorithms.

17. The system of claim 10, wherein the evaluation results include at least one of a temperature profile of the second processing circuit, power consumption of the second processing circuit for performing the inference, a number of operations per unit power consumption, frame per second (FPS), inference per second (IPS), or accuracy of the inference.

18. The system of claim 10, wherein the evaluation results are generated and sent from the second processing circuit to the first processing circuit on an epoch-by-epoch basis.

19. The system of claim 10, further comprising memory configured to store the first weights and the second weights from the first processing circuit for and sending to the second processing circuit.

20. A non-transitory computer readable storage medium in a neural processing unit storing updated weights of a neural network model thereon, the weights generated by:
obtaining previous weights of the neural network model by training or retraining the neural network model on a general-purpose graphics processing unit (GPGPU);
transferring the previous weights to the neural processing unit with limited capability relative to the GPGPU;
performing inference by the neural processing unit using neural network model and the transferred previous weights;
generating inference results and evaluation results on the performance of the inference at the neural processing unit using the neural network and the transferred previous weights, responsive to performing the inference by the neural processing unit;
sending the evaluation results to the GPGPU to modify a structure of the neural network model and to update the previous weights into updated weights by the GPGPU for execution on the neural processing unit;
sending the updated weights associated with an updated neural network model with the modified structure to the neural processing unit to the neural processing unit; and
performing inference by the neural processing unit using the updated neural network model and the updated weights.
